(19) United States
(12) Patent Application Publication
(10) Pub. No.: US 2013/0033524 A1
(43) Pub. Date: Feb. 7, 2013

(54) METHOD FOR PERFORMING DISPLAY CONTROL IN RESPONSE TO EYE ACTIVITIES OF A USER, AND ASSOCIATED APPARATUS

(71) Applicants: Chin-Han Wang, Taipei City (TW); Szu-Yu Chen, Taipei City (TW); Chi-Hsien Chen, Taipei City (TW)

(72) Inventors: Chin-Han Wang, Taipei City (TW); Szu-Yu Chen, Taipei City (TW); Chi-Hsien Chen, Taipei City (TW)

(21) Appl. No.: 13/195,855

(22) Filed: Aug. 2, 2011

(51) Int. Cl. G09G 5/00

(52) U.S. Cl. 345/684; 345/156

(57) ABSTRACT

A method for performing display control is provided, where the method is applied to an electronic device. The method includes: receiving image data of images of a user, wherein the images are captured by a camera module; and detecting eye activities of the user by analyzing the image data of the images, in order to determine whether to perform at least one scrolling operation. In particular, the step of detecting the eye activities of the user by analyzing the image data of the images in order to determine whether to perform the at least one scrolling operation further includes: when a specific eye activity is detected, performing a specific scrolling operation associated to the specific eye activity. An associated apparatus is also provided.

### BACKGROUND

The present invention relates to display control of an electronic device, and more particularly, to a method for performing display control in response to eye activities of a user, and to an associated apparatus.

According to the related art, a portable electronic device equipped with a touch screen (e.g., a multifunctional mobile phone, a personal digital assistant (PDA), a tablet, etc) can be utilized for displaying a document or a message to be read by an end user. In a situation where the document or the message comprises a lot of contents, some problems may occur. More specifically, the end user typically has to use one hand to hold the portable electronic device and use the other hand to control the portable electronic device when turning to another page is required, causing inconvenience since the end user may need to do something else with the other hand. For example, the end user is using one hand to hold the portable electronic device and is using the other hand to hold a cheeseburger in order to read and eat at the same time. When changing pages is required, for freely controlling the portable electronic device without messing up the touch screen thereof, the end user may be forced to put down the cheeseburger. In conclusion, the related art does not serve the end user well. Thus, a novel method is required for enhancing display control of an electronic device.

### SUMMARY

It is therefore an objective of the claimed invention to provide a method for performing display control in response to eye activities of a user, and to provide an associated apparatus, in order to solve the above-mentioned problems.

An exemplary embodiment of a method for performing display control is provided, where the method is applied to an electronic device. The method comprises: receiving image data of images of a user, wherein the images are captured by a camera module; and detecting eye activities of the user by analyzing the image data of the images, in order to determine whether to perform at least one scrolling operation. In particular, the step of detecting the eye activities of the user by analyzing the image data of the images in order to determine whether to perform the at least one scrolling operation further comprises: when a specific eye activity is detected, performing a specific scrolling operation associated to the specific eye activity.

An exemplary embodiment of an apparatus for performing display control is provided, where the apparatus comprises at least one portion of an electronic device. The apparatus comprises a storage and a processing circuit. The storage is arranged to temporarily store information. In addition, the processing circuit is arranged to control operations of the electronic device, receive image data of images of a user, and temporarily store the image data of the images into the storage, wherein the images are captured by a camera module, and the processing circuit is arranged to detect eye activities of the user by analyzing the image data, in order to determine whether to perform at least one scrolling operation. In particular, when a specific eye activity is detected, the processing circuit performs a specific scrolling operation associated to the specific eye activity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing display control according to a first embodiment of the present invention.

FIG. 2 illustrates the apparatus shown in FIG. 1 according to an embodiment of the present invention, where the apparatus of this embodiment is a mobile phone.

FIG. 3 illustrates a system comprising the apparatus shown in FIG. 1 according to another embodiment of the present invention, where the apparatus of this embodiment is a personal computer.

FIG. 4 illustrates a flowchart of a method for performing display control according to an embodiment of the present invention.

FIG. 5 illustrates a trace of a calibration tracker involved with the method shown in FIG. 4 according to an embodiment of the present invention.

FIG. 6 illustrates some predetermined regions involved with the method shown in FIG. 4 according to an embodiment of the present invention, where the predetermined regions of this embodiment comprise a predetermined central region and some predetermined boundary regions.

FIG. 7 illustrates some predetermined regions involved with the method shown in FIG. 4 according to another embodiment of the present invention, where the predetermined regions of this embodiment comprise a predetermined central region and some predetermined boundary regions.

FIG. 8 illustrates a line of sight of the user before his/her eye(s) travels along a predetermined direction according to an embodiment of the present invention.

FIG. 9 illustrates a line of sight of the user after his/her eye(s) travels along the predetermined direction according to the embodiment shown in FIG. 8.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

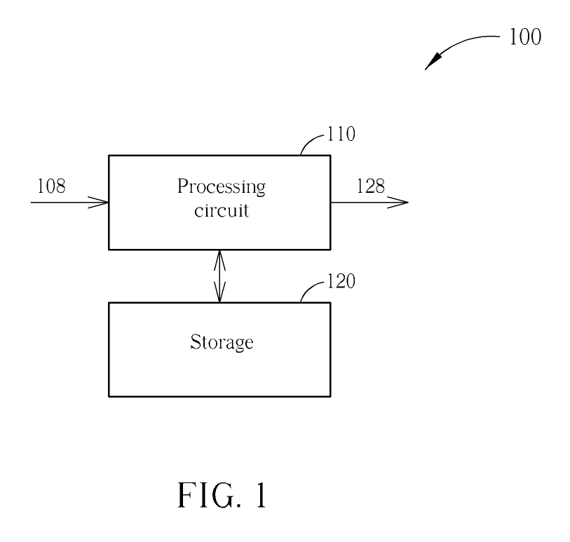

Please refer to FIG. 1, which illustrates a diagram of an apparatus 100 for performing display control according to a first embodiment of the present invention. According to different embodiments, such as the first embodiment and some variations thereof, the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. In another example, the apparatus 100 can be an audio/video system comprising the electronic device mentioned above. Examples of the electronic device may include, but not limited to, a mobile phone (e.g. a multifunctional mobile phone), a personal digital assistant (PDA), a portable electronic device such as the so-called tablet (based on a generalized definition), and a personal computer such as a tablet personal computer (which can also be referred to as the tablet, for simplicity), a laptop computer, or desktop computer.

As shown in FIG. 1, the apparatus 100 comprises a processing circuit 110 and a storage 120. The storage 120 is arranged to temporarily store information, such as information carried by at least one input signal 108 that is inputted into the processing circuit 110. For example, the storage 120 can be a memory (e.g. a volatile memory such as a random access memory (RAM), or a non-volatile memory such as a Flash memory), or can be a hard disk drive (HDD). In addition, the processing circuit 110 is arranged to control operations of the electronic device, receive image data of images of a user, and temporarily store the image data of the images into the storage 120, where the images are captured by a camera module. For example, the information carried by the aforementioned at least one input signal 108 may comprise the image data mentioned above. Additionally, the processing circuit 110 is arranged to detect eye activities of the user by analyzing the image data, in order to determine whether to perform at least one scrolling operation, such as one or more of a scrolling up operation, a scrolling down operation, a scrolling right operation, a scrolling left operation, a page up operation, and a page down operation. For example, when a specific eye activity of the user is detected, the processing circuit 110 performs a specific scrolling operation associated to the specific eye activity. As a result, the video contents that the user is viewing through a screen may be scrolled by the specific scrolling operation. Examples of the source of the video contents may comprise a document, a message, a file, a webpage, a program, an application, etc., and at least one output signal 128 may carry information of a scrolled result of the specific scrolling operation, such as information of the video contents that the user is going to view through the screen mentioned above.

More particularly, the specific eye activity mentioned above is an intentional eye activity of the user. Here, the intentional eye activity represents an eye activity that is intentionally utilized for controlling the apparatus 100 or the electronic device. In practice, the apparatus 100 or an accessory thereof may comprise a confirmation node/pad/button (not shown in FIG. 1) for determining whether an eye activity of the user is an intentional eye activity, where the confirmation node/pad/button can be positioned within/on the apparatus 100 or the accessory thereof. More specifically, the processing circuit 110 is arranged to detect whether the confirmation node/pad/button is touched/pressed by the user, in order to determine whether an eye activity of the eye activities mentioned above is an intentional eye activity of the user.

For example, in a situation where the confirmation node/pad/button is positioned at one side of the electronic device, the user may use one finger of his/her hand that is holding the electronic device (e.g. the thumb or one of the other fingers) to touch/press the confirmation node/pad/button, in order to confirm that the eye activity under consideration is an intentional eye activity. In another example, in a situation where the confirmation node/pad/button is positioned on the accessory of the apparatus 100, such as a remote control, the user may use one finger that is holding the accessory (e.g. the thumb or one of the other fingers) to touch/press the confirmation node/pad/button, in order to confirm that the eye activity under consideration is an intentional eye activity. When it is detected that the confirmation node/pad/button is touched/pressed by the user, the eye activity under consideration is determined to be an intentional eye activity of the user. As a result of implementing the confirmation node/pad/button, an improper operation of performing a scrolling operation in response to an unintentional eye activity of the user can be prevented. Thus, as long as the confirmation node/pad/button is not touched/pressed, the user can look at something else freely when needed.

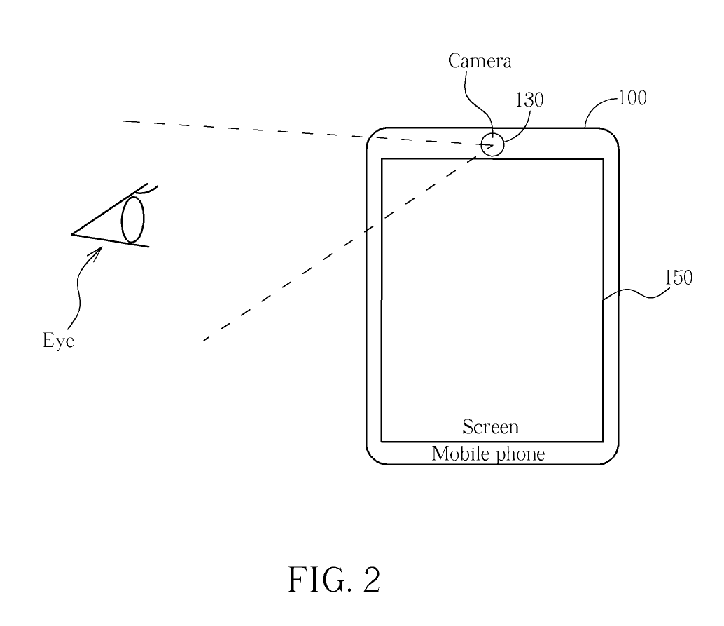

FIG. 2 illustrates the apparatus 100 shown in FIG. 1 according to an embodiment of the present invention, where the apparatus 100 of this embodiment is a mobile phone, and therefore, is labeled “Mobile phone” in FIG. 2. A camera module 130 (labeled “Camera” in FIG. 2, for brevity) is taken as an example of the camera module mentioned in the first embodiment, and is installed within the apparatus 100 mentioned above (i.e. the mobile phone in this embodiment), which means the apparatus 100 comprises the camera module 130. According to this embodiment, the camera module 130 is positioned around an upper side of the apparatus 100. This is for illustrative purposes only, and is not meant to be a limitation of the present invention. According to some variations of this embodiment, the camera module 130 can be positioned around another side of the apparatus 100. In addition, a touch screen 150 (labeled “Screen” in FIG. 2, for brevity) is taken as an example of the screen mentioned in the first embodiment, and is installed within the apparatus 100 mentioned above, which means the apparatus 100 comprises the touch screen 150. As shown in FIG. 2, the camera module 130 can be utilized for capturing the images of the user, and more particularly, the images of the face of the user. For example, by analyzing the image data of the images, the processing circuit 110 can extract eye images of the eye(s) of the user, and detect the eye activities according to the eye images (more particularly, according to the pupil orientation of the eye(s) in the eye images). In response to the eye activities of the user, the processing circuit 110 can determine whether to perform the aforementioned at least one scrolling operation.

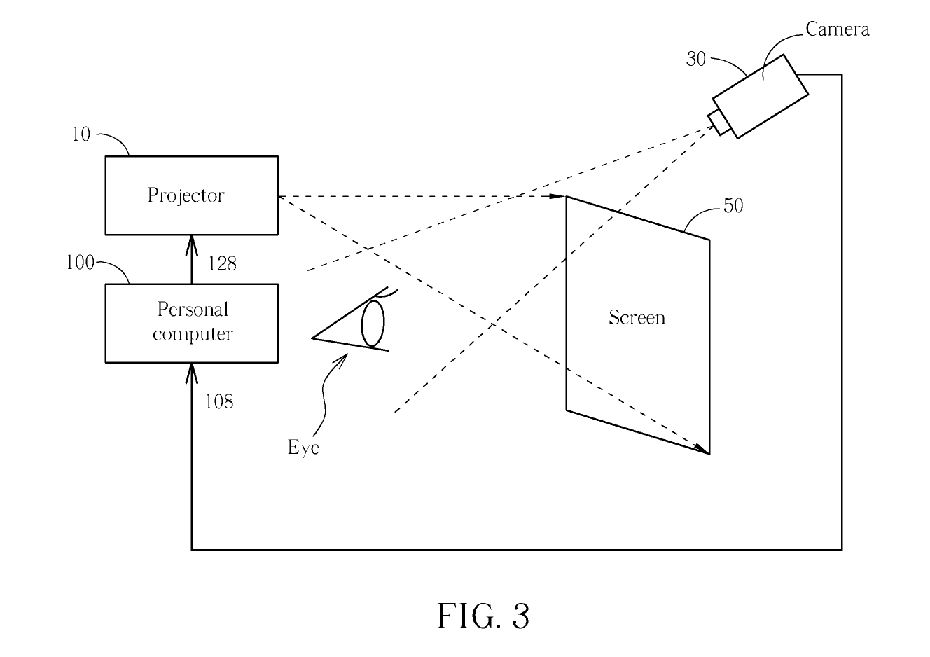

FIG. 3 illustrates a system comprising the apparatus 100 shown in FIG. 1 according to another embodiment of the present invention, where the apparatus 100 of this embodiment is a personal computer, and therefore, is labeled “Personal computer” in FIG. 3. A screen 50 is taken as an example of the screen mentioned in the first embodiment, and is installed outside the apparatus 100 mentioned above (i.e. the personal computer in this embodiment). In addition, a projector 10 that is coupled to the apparatus 100 receives the aforementioned output signal 128, and projects some video contents onto the screen 50 according to the information carried by the output signal 128. Additionally, a camera module 30 (labeled “Camera” in FIG. 3, for brevity) is taken as an example of the camera module mentioned in the first embodiment, and is installed outside the apparatus 100 mentioned above, where the apparatus 100 receives the aforementioned input signal 108 from the camera module 30. According to this embodiment, the camera module 30 is positioned around an upper side of the screen 50. This is for illustrative purposes only, and is not meant to be a limitation of the present invention. According to some variations of this embodiment, the camera module 30 can be positioned around another side of the screen 50. As shown in FIG. 3, the camera module 30 can be utilized for capturing the images of the user, and more particularly, the images of the face of the user. For example, by analyzing the image data of the images, the processing circuit 110 can extract eye images of the eye(s) of the user, and detect the eye activities according to the eye images (more particularly, according to the pupil orientation of the eye(s) in the eye images). In response to the eye activities of the user, the processing circuit 110 can determine whether to perform the aforementioned at least one scrolling operation.

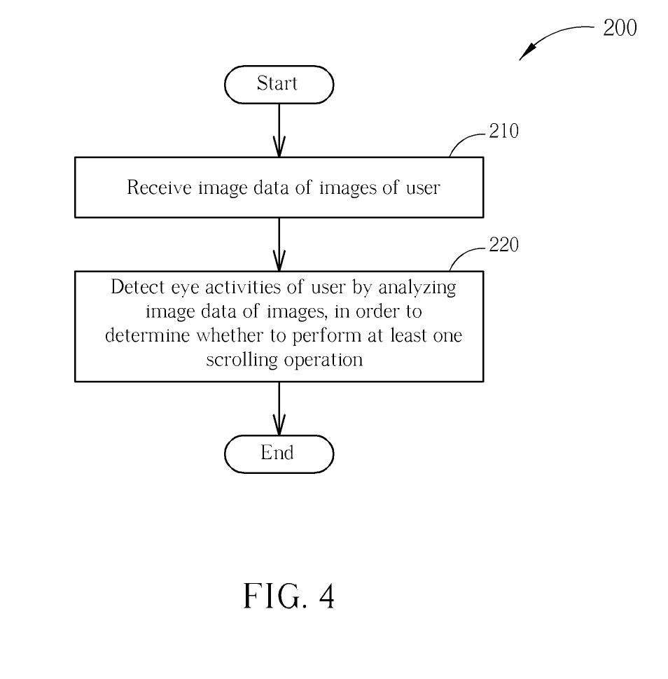

FIG. 4 illustrates a flowchart of a method 200 for performing display control according to an embodiment of the present invention. The method shown in FIG. 4 can be applied to the apparatus 100 shown in FIG. 1. The method is described as follows.

In Step 210, the processing circuit 110 receives image data of images of the user, such as the aforementioned image data of the images of the user, where the images are captured by a camera module such as that mentioned in the first embodiment. Examples of the camera module under consideration may include, but not limited to, the camera module 130 shown in FIG. 2 and the camera module 30 shown in FIG. 3.

In Step 220, the processing circuit 110 detects the eye activities of the user by analyzing the image data of the images, in order to determine whether to perform the aforementioned at least one scrolling operation. More particularly, when a specific eye activity such as that mentioned above is detected, the processing circuit 110 performs a specific scrolling operation associated to the specific eye activity, such as the specific scrolling operation mentioned in the first embodiment.

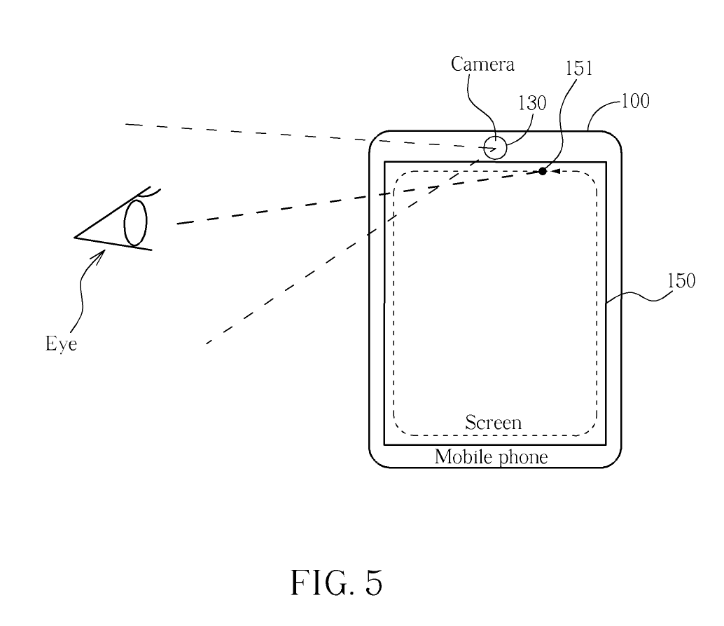

According to this embodiment, the processing circuit 110 can perform a calibration process in advance, in order to correctly detect the eye activities of the user by analyzing the image data of the images. FIG. 5 illustrates a trace of a calibration tracker 151 involved with the method 200 shown in FIG. 4 according to an embodiment of the present invention. For better comprehension, the mobile phone of the embodiment shown in FIG. 2 is taken as an example of the apparatus 100. During the calibration process mentioned above, the processing circuit 110 controls the calibration tracker 151 (e.g. a spot like pattern in this embodiment, or other types of patterns in different variations of this embodiment) to travel along the trace illustrated with the dashed curve within the display area of the touch screen 150 (labeled “Screen” in FIG. 5, for brevity), where most portions of the trace of this embodiment are near the boundaries of the touch screen 150. For example, the trace can be displayed on the touch screen 150, for giving a hint to the user. In another example, the trace can be hidden, which means it is not displayed on the touch screen 150 at all.

In practice, before the calibration process starts, the processing circuit 110 may output a video hint through the touch screen 150 or an audio hint through a speaker (not shown) of the apparatus 100, in order to guide the user to look at the calibration tracker 151 during the calibration process. When the calibration process starts, the calibration tracker 151 starts traveling around and the user keeps looking at the calibration tracker 151, and the processing circuit 110 utilizes the camera module 130 to capture calibration images of the user, and more particularly, the images of the face of the user. By analyzing eye images within the calibration images that are captured during the calibration process, the processing circuit 110 can establish a database, where the database can be utilized as a reference for detecting the eye activities of the user. For example, the database may comprise reference data of at least one mapping relationship between a line of sight of the user and a location (or a set of coordinate values) on the touch screen 150.

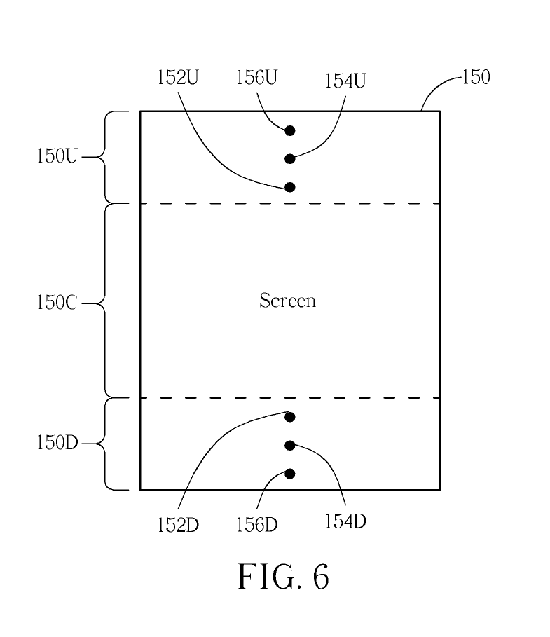

FIG. 6 illustrates some predetermined regions involved with the method 200 shown in FIG. 4 according to an embodiment of the present invention, where the predetermined regions of this embodiment comprise a predetermined central region 150C and a plurality of predetermined boundary regions such as two predetermined boundary regions 150U and 150D. Based upon the calibration process performed in advance (or the database mentioned above), the specific eye activity may indicate that the user looks at a predetermined boundary region of the touch screen 150. In this situation, the processing circuit 110 determines the specific scrolling operation to be a scrolling operation toward the same side of the predetermined boundary region with respect to the center of the touch screen 150. More particularly, based upon the calibration process performed in advance (or the database mentioned above), the specific eye activity indicates that the user looks at the predetermined boundary region of the touch screen 150 for a time period that is greater than a predetermined threshold (e.g. one second, or a fixed value that is greater than one second, or a fixed value that is less than one second).

For example, the predetermined boundary region is located at the upper side, and represents the predetermined boundary region 150U, and therefore, the processing circuit 110 determines the specific scrolling operation to be a scrolling up operation. In another example, the predetermined boundary region is located at the lower side, and represents the predetermined boundary region 150D, and therefore, the processing circuit 110 determines the specific scrolling operation to be a scrolling down operation. Please note that, in a situation where the user looks at predetermined central region 150C, the processing circuit 110 of this embodiment does not trigger any scrolling operation since the user may want to keep reading the video contents that are currently displayed on the touch screen 150.

More particularly, the processing circuit 110 may change the scrolling speed of the specific scrolling operation in response to the location where the user looks at. Based upon the calibration process performed in advance (or the database mentioned above), the specific eye activity may indicate that the user looks at a predetermined sub-region of the predetermined boundary region mentioned above, such as a predetermined sub-region comprising one of the points 152U, 154U, and 156U or a predetermined sub-region comprising one of the points 152D, 154D, and 156D.

For example, the scrolling speed of the scrolling up operation performed in a situation where the specific eye activity indicates that the user looks at the point 152U is lower than the scrolling speed of the scrolling up operation performed in a situation where the specific eye activity indicates that the user looks at the point 154U. In another example, the scrolling speed of the scrolling up operation performed in a situation where the specific eye activity indicates that the user looks at the point 156U is higher than the scrolling speed of the scrolling up operation performed in a situation where the specific eye activity indicates that the user looks at the point 154U. In another example, the scrolling speed of the scrolling down operation performed in a situation where the specific eye activity indicates that the user looks at the point 152D is lower than the scrolling speed of the scrolling down operation performed in a situation where the specific eye activity indicates that the user looks at the point 154D. In another example, the scrolling speed of the scrolling down operation performed in a situation where the specific eye activity indicates that the user looks at the point 156D is higher than the scrolling speed of the scrolling down operation performed in a situation where the specific eye activity indicates that the user looks at the point 154D. This is for illustrative purposes only, and is not meant to be a limitation of the present invention. According to some variations of this embodiment, the one-dimensional scheme regarding the scrolling speed control of this embodiment can be extended to a two-dimensional scheme in these variations. Similar descriptions are not repeated in detail for these variations.

According to a variation of this embodiment, the scrolling up operation can be a page up operation, and the scrolling down operation can be a page down operation. Similar descriptions are not repeated in detail for this variation.

According to some variations of this embodiment, at least a portion (e.g. a portion or all) of the plurality of predetermined boundary regions under consideration, such as at least one predetermined boundary sub-region and/or at least one predetermined boundary region, may be positioned outside the screen under consideration (e.g. the screen 150 or the screen 50). For example, the two predetermined boundary regions 150U and 150D may be extended to cover some predetermined boundary sub-regions outside the screen 150, respectively. In another example, in addition to the two predetermined boundary regions 150U and 150D, the plurality of predetermined boundary regions under consideration may comprise a first predetermined boundary region above the predetermined boundary region 150U, and further comprise a second predetermined boundary region below the predetermined boundary region 150D, where the first predetermined boundary region can be regarded as the extension of the predetermined boundary region 150U, and the second predetermined boundary region can be regarded as the extension of the predetermined boundary region 150D. Thus, the plurality of predetermined boundary regions under consideration can be regarded as predetermined boundary regions of/outside the screen. Similar descriptions are not repeated in detail for these variations.

According to another variation of this embodiment, all of the plurality of predetermined boundary regions under consideration may be positioned outside the screen under consideration (e.g. the screen 150 or the screen 50). For example, the size of the predetermined central region 150C can be equal to the size of the screen 150, where the arrangement of the plurality of predetermined boundary regions with respect to the predetermined central region 150C can be the same as that shown in FIG. 6. That is, the predetermined boundary region 150U is still above the predetermined central region 150C, and the predetermined boundary region 150D is still below the predetermined central region 150C. Thus, the plurality of predetermined boundary regions under consideration can be regarded as predetermined boundary regions outside the screen. Similar descriptions are not repeated in detail for this variation.

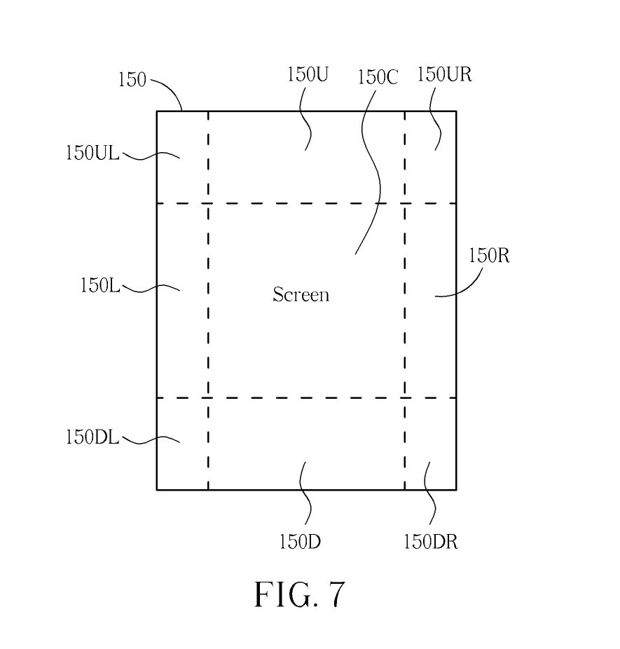

FIG. 7 illustrates some predetermined regions involved with the method 200 shown in FIG. 4 according to another embodiment of the present invention, where the predetermined regions of this embodiment comprise a predetermined central region 150C and a plurality of predetermined boundary regions such as eight predetermined boundary regions 150UL, 150U, 150UR, 150L, 150R, 150DL, 150D, and 150DR, given that the one-dimensional scheme of the embodiment shown in FIG. 6 can be extended to a two-dimensional scheme in this embodiment.

For example, the predetermined boundary region is located at the upper side, and represents the predetermined boundary region 150U, and therefore, the processing circuit 110 determines the specific scrolling operation to be a scrolling up operation. In another example, the predetermined boundary region is located at the lower side, and represents the predetermined boundary region 150D, and therefore, the processing circuit 110 determines the specific scrolling operation to be a scrolling down operation. In another example, the predetermined boundary region is located at the right side, and represents the predetermined boundary region 150R, and therefore, the processing circuit 110 determines the specific scrolling operation to be a scrolling right operation. In another example, the predetermined boundary region is located at the left side, and represents the predetermined boundary region 150L, and therefore, the processing circuit 110 determines the specific scrolling operation to be a scrolling left operation.

Regarding the other predetermined boundary regions, the specific scrolling operation will be a combination of associated scrolling operations respectively corresponding to two directions. For example, the predetermined boundary region is located at the upper left corner, and represents the predetermined boundary region 150UL, and therefore, the processing circuit 110 determines the specific scrolling operation to be a combination of the scrolling up operation and the scrolling left operation. In another example, the predetermined boundary region is located at the lower left corner, and represents the predetermined boundary region 150DL, and therefore, the processing circuit 110 determines the specific scrolling operation to be a combination of the scrolling down operation and the scrolling left operation. In another example, the predetermined boundary region is located at the upper right corner, and represents the predetermined boundary region 150UR, and therefore, the processing circuit 110 determines the specific scrolling operation to be a combination of the scrolling up operation and the scrolling right operation. In another example, the predetermined boundary region is located at the lower right corner, and represents the predetermined boundary region 150DR, and therefore, the processing circuit 110 determines the specific scrolling operation to be a combination of the scrolling down operation and the scrolling right operation. Similar descriptions are not repeated in detail for this embodiment.

According to some variations of this embodiment, at least a portion (e.g. a portion or all) of the plurality of predetermined boundary regions under consideration, such as at least one predetermined boundary sub-region and/or at least one predetermined boundary region, may be positioned outside the screen under consideration (e.g. the screen 150 or the screen 50). For example, the eight predetermined boundary regions 150UL, 150U, 150UR, 150L, 150R, 150DL, 150D, and 150DR may be extended to cover some predetermined boundary sub-regions outside the screen 150, respectively. In another example, in addition to the eight predetermined boundary regions 150UL, 150U, 150UR, 150L, 150R, 150DL, 150D, and 150DR, the plurality of predetermined boundary regions under consideration may comprise a first predetermined boundary region above the predetermined boundary region 150U, a second predetermined boundary region below the predetermined boundary region 150D, a third predetermined boundary region adjacent to the left of the predetermined boundary region 150L, and a fourth predetermined boundary region adjacent to the right of the predetermined boundary region 150R, and further comprise a fifth predetermined boundary region adjacent to the outer boundary of the predetermined boundary region 150UL, a sixth predetermined boundary region adjacent to the outer boundary of the predetermined boundary region 150DL, a seventh predetermined boundary region adjacent to the outer boundary of the predetermined boundary region 150UR, and an eighth predetermined boundary region adjacent to the outer boundary of the predetermined boundary region 150DR. Similarly, the first, the second, the third, the fourth, the fifth, the sixth, the seventh, and the eighth predetermined boundary regions can be regarded as the extension of the predetermined boundary regions 150U, 150D, 150L, 150R, 150UL, 150DL, 150UR, and 150DR, respectively. Thus, the plurality of predetermined boundary regions under consideration can be regarded as predetermined boundary regions of/outside the screen. Similar descriptions are not repeated in detail for these variations.

According to another variation of this embodiment, all of the plurality of predetermined boundary regions under consideration may be positioned outside the screen under consideration (e.g. the screen 150 or the screen 50). For example, the size of the predetermined central region 150C can be equal to the size of the screen 150, where the arrangement of the plurality of predetermined boundary regions with respect to the predetermined central region 150C can be the same as that shown in FIG. 7. That is, the predetermined boundary region 150U is still above the predetermined central region 150C, the predetermined boundary region 150D is still below the predetermined central region 150C, the predetermined boundary region 150L is still adjacent to the left of the predetermined central region 150C, and the predetermined boundary region 150R is still adjacent to the right of the predetermined central region 150C. Similarly, the predetermined boundary region 150UL is still adjacent to the upper left corner of the predetermined central region 150C, the predetermined boundary region 150DL is still adjacent to the lower left corner of the predetermined central region 150C, the outer boundary of the predetermined boundary region 150UR is still adjacent to the upper right corner of the predetermined central region 150C, and the predetermined boundary region 150DR is still adjacent to the lower right corner of the predetermined central region 150C. Thus, the plurality of predetermined boundary regions under consideration can be regarded as predetermined boundary regions outside the screen. Similar descriptions are not repeated in detail for this variation.

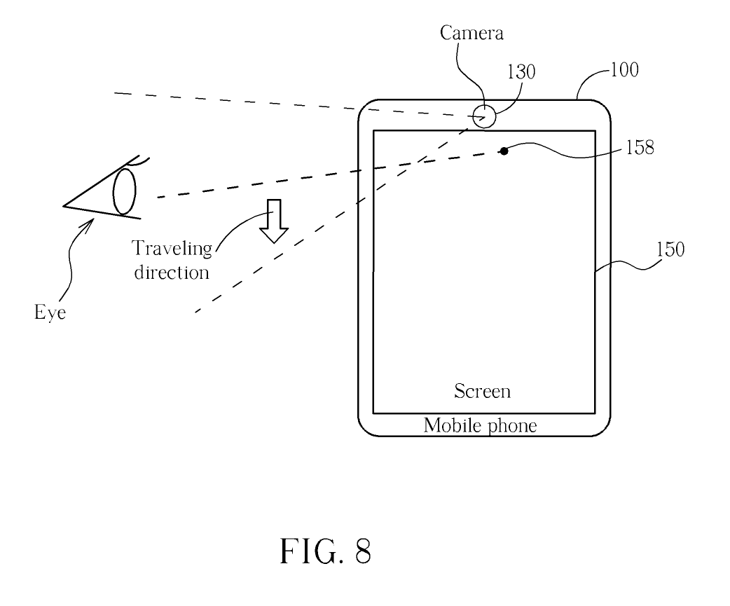

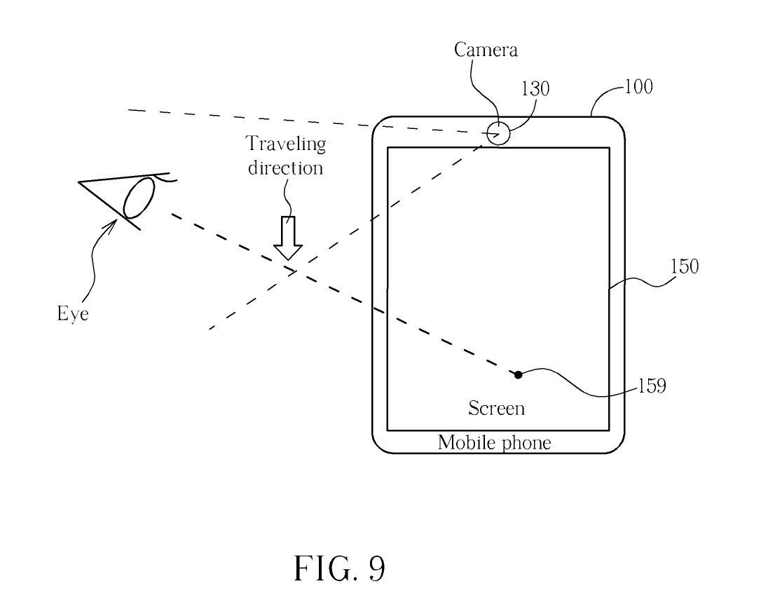

FIG. 8 illustrates the line of sight of the user before his/her eye(s) travels along a predetermined direction according to an embodiment of the present invention, while FIG. 9 illustrates the line of sight of the user after his/her eye(s) travels along the predetermined direction according to the same embodiment. For better comprehension, the mobile phone of the embodiment shown in FIG. 2 is taken as an example of the apparatus 100. According to this embodiment, based upon the calibration process performed in advance (or the database mentioned above), the specific eye activity may indicate that the line of sight of the user travels along a predetermined direction such as that mentioned above. In this situation, the processing circuit 110 determines the specific scrolling operation to be a scrolling operation toward the opposite direction of the predetermined direction.

For example, the predetermined direction is a down direction (e.g., in the situation illustrated in FIG. 8 and FIG. 9), and therefore, the processing circuit 110 determines the specific scrolling operation to be a scrolling up operation. As a result of the scrolling up operation, the processing circuit 110 controls the hidden/non-displayed video contents above the currently displayed video contents (e.g. the hidden/non-displayed video contents of the previous page, such as those of the end of the previous page) to be displayed. In another example, the predetermined direction is an up direction, and therefore, the processing circuit 110 determines the specific scrolling operation to be a scrolling down operation. As a result of the scrolling down operation, the processing circuit 110 controls the hidden/non-displayed video contents below the currently displayed video contents (e.g. the hidden/non-displayed video contents of the next page, such as those of the beginning of the next page) to be displayed. This is for illustrative purposes only, and is not meant to be a limitation of the present invention. According to some variations of this embodiment, the one-dimensional scheme of this embodiment can be extended to a two-dimensional scheme in these variations. For example, the predetermined direction is a right direction, and therefore, the processing circuit 110 determines the specific scrolling operation to be a scrolling left operation. In another example, the predetermined direction is a left direction, and therefore, the processing circuit 110 determines the specific scrolling operation to be a scrolling right operation.

According to a variation of this embodiment, based upon the calibration process performed in advance (or the database mentioned above), the specific eye activity may indicate that the line of sight of the user travels along a predetermined direction such as that mentioned above. In this situation, the processing circuit 110 determines the specific scrolling operation to be a scrolling operation toward the predetermined direction.

For example, the predetermined direction is a down direction (e.g., in the situation illustrated in FIG. 8 and FIG. 9), and therefore, the processing circuit 110 determines the specific scrolling operation to be a scrolling down operation. In another example, the predetermined direction is an up direction, and therefore, the processing circuit 110 determines the specific scrolling operation to be a scrolling up operation. In another example, the predetermined direction is a right direction, and therefore, the processing circuit 110 determines the specific scrolling operation to be a scrolling right operation. In another example, the predetermined direction is a left direction, and therefore, the processing circuit 110 determines the specific scrolling operation to be a scrolling left operation. Similar descriptions are not repeated in detail for this variation.

According to another variation of this embodiment, the specific eye activity may represent that the user blinks his/her eye(s). For example, when the user blinks his/her eye(s), the processing circuit 110 determines the specific scrolling operation to be a scrolling down operation. In another example, when the user blinks his/her eye(s), the processing circuit 110 determines the specific scrolling operation to be a page down operation. Similar descriptions are not repeated in detail for this variation.

According to another variation of this embodiment, the specific eye activity may represent that the user blinks his/her eye(s), and the processing circuit 110 determines the specific scrolling operation to be a scrolling operation associated to the number of times that the user continuously blinks his/her eye(s). For example, when the number of times that the user continuously blinks his/her eye(s) is equal to one, which means the user blinks his/her eye(s) one time, the processing circuit 110 determines the specific scrolling operation to be a scrolling down operation, and more particularly, a page down operation. In another example, when the number of times that the user continuously blinks his/her eye(s) is equal to two, which means the user continuously blinks his/her eye(s) two times, the processing circuit 110 determines the specific scrolling operation to be a scrolling up operation, and more particularly, a page up operation. Similar descriptions are not repeated in detail for this variation.

It is an advantage of the present invention that the present invention method and apparatus allow the user to freely control an electronic device by using his/her eye activities. In addition, in a situation where the electronic device is a portable electronic device equipped with a touch screen and the user is reading and eating at the same time, when a scrolling operation is required, the present invention method and apparatus can prevent the user from messing up the touch screen. As a result, the user can turn to another page with ease, where the related art problems (e.g. the user may be forced to put down the cheeseburger that he/she is eating) will no longer be an issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing display control, the method being applied to an electronic device, the method comprising:
receiving image data of images of a user, wherein the images are captured by a camera module; and
detecting eye activities of the user by analyzing the image data of the images, in order to determine whether to perform at least one scrolling operation, wherein the step of detecting the eye activities of the user by analyzing the image data of the images in order to determine whether to perform the at least one scrolling operation further comprises:
when a specific eye activity is detected, performing a specific scrolling operation associated to the specific eye activity.

2. The method of claim 1, wherein based upon a calibration process performed in advance, the specific eye activity indicates that the user looks at a predetermined boundary region of/outside a screen; and the method further comprises:
determining the specific scrolling operation to be a scrolling operation toward a same side of the predetermined boundary region with respect to a center of the screen.

3. The method of claim 2, wherein based upon the calibration process performed in advance, the specific eye activity indicates that the user looks at the predetermined boundary region of/outside the screen for a time period that is greater than a predetermined threshold.

4. The method of claim 2, wherein the predetermined boundary region is located at an upper side, a lower side, a right side, or a left side of the screen.

5. The method of claim 1, wherein based upon the calibration process performed in advance, the specific eye activity indicates that a line of sight of the user travels along a predetermined direction; and the method further comprises:
determining the specific scrolling operation to be a scrolling operation toward the predetermined direction or an opposite direction thereof.

6. The method of claim 5, wherein the predetermined direction is an up direction, a down direction, a right direction, or a left direction.

7. The method of claim 1, wherein the specific eye activity represents that the user blinks his/her eye(s).

8. The method of claim 7, further comprising:
determining the specific scrolling operation to be a scrolling operation associated to a number of times that the user continuously blinks his/her eye(s).

9. The method of claim 1, wherein the specific eye activity is an intentional eye activity of the user; and the method further comprises:
detecting whether a confirmation node/pad/button is touched/pressed by the user, in order to determine whether an eye activity of the eye activities is an intentional eye activity of the user, wherein when it is detected that the confirmation node/pad/button is touched/pressed by the user, the eye activity is determined to be an intentional eye activity of the user.

10. The method of claim 1, wherein the scrolling operation comprises a page up/page down operation.

11. An apparatus for performing display control, the apparatus comprising at least one portion of an electronic device, the apparatus comprising:
a storage arranged to temporarily store information; and
a processing circuit arranged to control operations of the electronic device, receive image data of images of a user, and temporarily store the image data of the images into the storage, wherein the images are captured by a camera module, and the processing circuit is arranged to detect eye activities of the user by analyzing the image data, in order to determine whether to perform at least one scrolling operation;
wherein when a specific eye activity is detected, the processing circuit performs a specific scrolling operation associated to the specific eye activity.

12. The apparatus of claim 11, wherein based upon a calibration process performed in advance, the specific eye activity indicates that the user looks at a predetermined boundary region of/outside a screen; and the processing circuit determines the specific scrolling operation to be a scrolling operation toward a same side of the predetermined boundary region with respect to a center of the screen.

13. The apparatus of claim 12, wherein based upon the calibration process performed in advance, the specific eye activity indicates that the user looks at the predetermined boundary region of/outside the screen for a time period that is greater than a predetermined threshold.

14. The apparatus of claim 12, wherein the predetermined boundary region is located at an upper side, a lower side, a right side, or a left side of the screen.

15. The apparatus of claim 11, wherein based upon the calibration process performed in advance, the specific eye activity indicates that a line of sight of the user travels along a predetermined direction; and the processing circuit determines the specific scrolling operation to be a scrolling operation toward the predetermined direction or an opposite direction thereof.

16. The apparatus of claim 15, wherein the predetermined direction is an up direction, a down direction, a right direction, or a left direction.

17. The apparatus of claim 11, wherein the specific eye activity represents that the user blinks his/her eye(s).

18. The apparatus of claim 17, wherein the processing circuit determines the specific scrolling operation to be a scrolling operation associated to a number of times that the user continuously blinks his/her eye(s).

19. The apparatus of claim 11, wherein the specific eye activity is an intentional eye activity of the user; and the processing circuit is arranged to detect whether a confirmation node/pad/button is touched/pressed by the user, in order to determine whether an eye activity of the eye activities is an intentional eye activity of the user, wherein when it is detected that the confirmation node/pad/button is touched/pressed by the user, the eye activity is determined to be an intentional eye activity of the user.

20. The apparatus of claim 11, wherein the scrolling operation comprises a page up/page down operation.
